(19) United States
(12) Patent Application Publication
(10) Pub. No.: US 2005/0144826 A1
(43) Pub. Date: Jul. 7, 2005

(54) Media organizer label system and method

(76) Inventor: Mary Teresa Murphy, Petaluma, CA (US)

Correspondence Address: Kevin J. McNeely, 5301 Wriley Road, Bethesda, MD, 20816, US

(21) Appl. No.: 10/828,847

(22) Filed: Apr. 21, 2004

Related U.S. Application Data
(60) Provisional application No. 60/534,411, filed on Jan. 7, 2004.

(51) Int. Cl. G09F 23/10

(52) U.S. Cl. 40/641

(57) ABSTRACT

A label for a media disk storage device having more than one pocket moveably attached to a binder in a stacked arrangement includes an insertion card insertable within the pocket and an identifier tab extending from the insertion card to a position beyond an edge of the pocket when the insertion card is inserted in the pocket.

### CROSS REFERENCE TO RELATED APPLICATIONS

This application claims priority from U.S. Provisional Application No. 60/534411 filed on Jan. 7, 2004, which is incorporated herein by reference.

### FIELD OF THE INVENTION

The invention described herein relates to labeling systems, and more specifically, to labeling of compact disks (CDs), digital video disks (DVDs) and other digital media stored in organizers.

### BACKGROUND OF THE INVENTION

CDs and DVDs are frequently stored in various types of organizers. A popular type of CD organizer has a front and back cover with a spine. Multiple pockets are attached to the spine between the covers, similar to the pages of a book. The user can then flip through their CD collection to locate a desired selection. However, as the number of CDs increase, it becomes more difficult to locate a specific CD by flipping through each pocket. Thus, a need exists for a labeling system to quickly locate a desired CD.

### SUMMARY OF THE INVENTION

In one general aspect, a label for a media disk storage device having more than one pocket moveably attached to a binder in a stacked arrangement includes an insertion card insertable within the pocket and an identifier tab extending from the insertion card to a position beyond an edge of the pocket when the insertion card is inserted in the pocket.

Implementation may include one or more of the following features. For example, the identifier tab may have a printable surface and an identifier on the identifier tab may be a symbol. The identifier tab also may have a semi-circular shape or rectangular shape. The insertion card may have a rectangular, circular, or square shape.

In another general aspect, a media disk label system for a media disk organizer having a first pocket, a second pocket, and a third pocket moveably attached to a binder in a stacked arrangement includes a first label having a first insert portion and a first tab extending from a left side of the first insert portion to a position beyond an edge of the first pocket when the first insert portion is positioned in the first pocket, a second label having a second insert portion and a second tab extending from a middle-portion of the second insert portion to a position beyond an edge of the second pocket when the second insert portion is positioned in the second pocket, and a third label having a third insert portion and a third tab extending from a right side of the third insert portion to a position beyond an edge of the third pocket when the third insert portion is positioned in the third pocket.

Implementation may include one or more of the following features or any of the features described above. For example, the label system may include an index referencing a location of media disks stored in the first pocket, the second pocket, and the third pocket, the index being attachable to the organizer. The label system may also include a sheet having perforations configured for separation into the first label, the second label, and the third label, each of the labels having a printable surface.

In a further general aspect, a method of organizing media disks in a disk holder having more than one pocket moveably attached to a binder includes providing a label having an insert portion and an identifier tab extending from the insert portion, the identifier tab being visible when the insert portion is inserted in the pocket.

The method may include one or more of the following features or any of the features described above. For example, the method may include printing an identifier on the tab and providing an index having the identifier identifying a media disk stored in the pocket. The method may also include inserting the insert portion of the label into each pocket of the disk holder and/or providing a computer program operable to instruct a computer system having a printer to print an identifier on the label.

In another general aspect, the computer program may include instructions to cause a printer to print an outline of a label having an insert portion and a tab extending from the insert portion.

The computer program may also include one or more of the following features or any of the features described above. For example, the instructions may cause a computer user interface to prompt a user for an identifier and cause the printer to print the identifier on a printable surface of the identifier tab. The instructions may also cause the printer to print an index having the identifier.

In another implementation the instructions may cause a computer user interface to prompt a user to load a sheet of label stock in a printer, the label stock having perforations configured in the shape of the label. The instructions may also assign an identifier to each label and cause the printer to print the identifier on each label and on an index. The instructions may further cause a computer user interface to prompt the user to print the label.

### BRIEF DESCRIPTION OF THE DRAWINGS

Reference numerals in the drawings correspond to numbers in the Detailed Description for ease of reference.

FIGS. 1 and 2 illustrate labels for a media organizer.

FIGS. 3 and 4 illustrate media organizers with the labels shown in FIGS. 1 and 2 inserted in separate pockets.

FIG. 5 illustrates a series of labels.

FIGS. 6 and 7 illustrate media organizers with the labels shown in FIG. 5.

FIG. 8. illustrates a media organizer with labels and an index.

FIG. 9 illustrates a method of producing labels for a media organizer.

### DETAILED DESCRIPTION

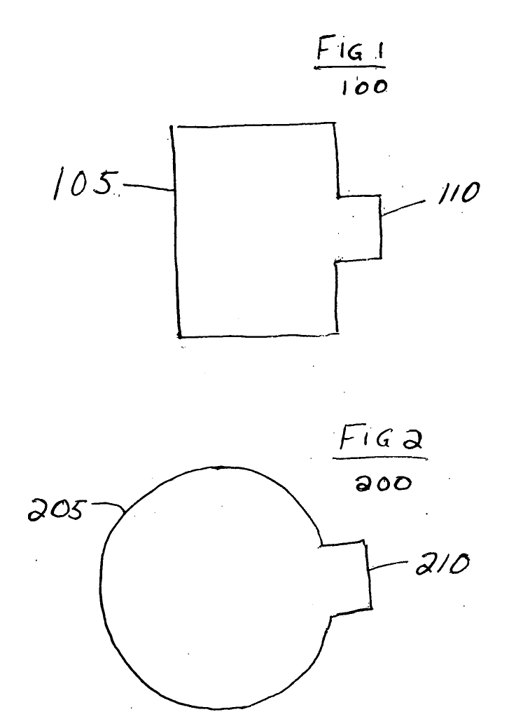

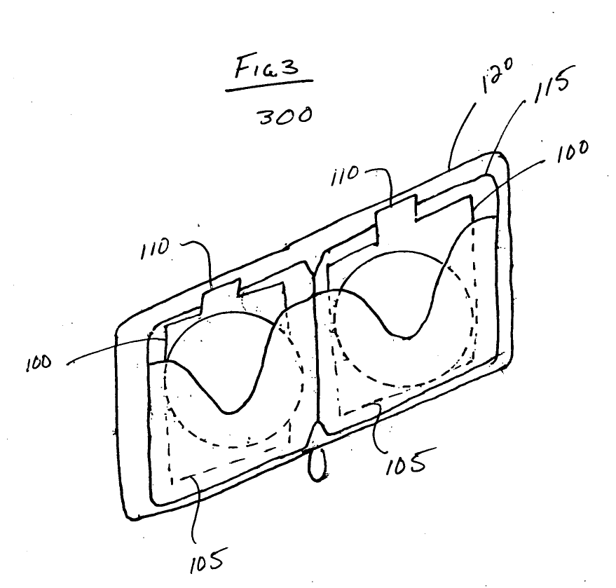

Referring to FIGS. 1 and 2, a label 100, 200 for a CD organizer includes an insertion card 105, 205 with an identifier tab 110, 210 extending from the insertion card. Referring to FIG. 1, the shape of the insertion card 105 may be rectangular or, referring to FIG. 2, the shape of the insertion card 205 may also be circular.

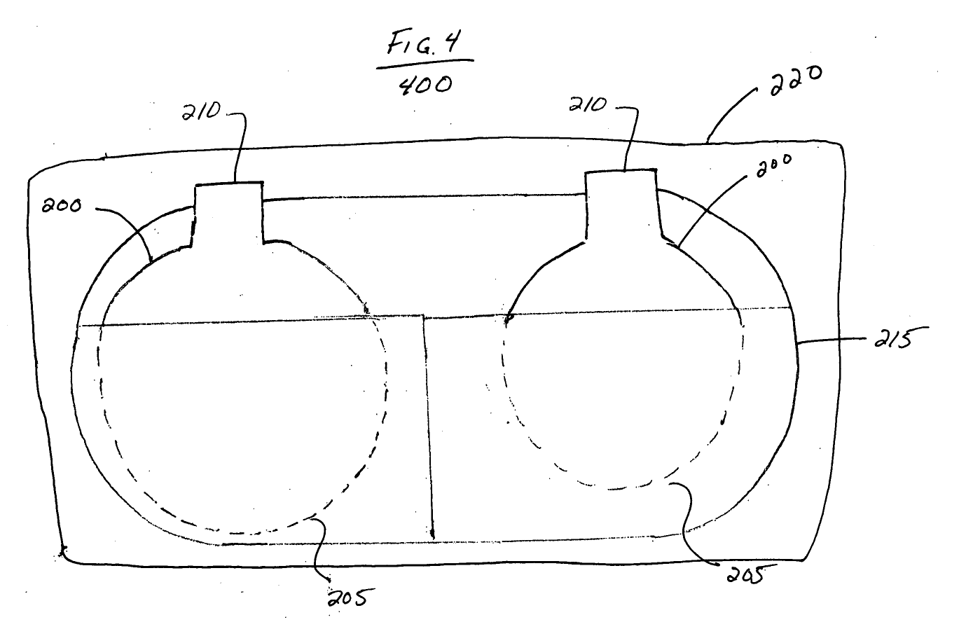

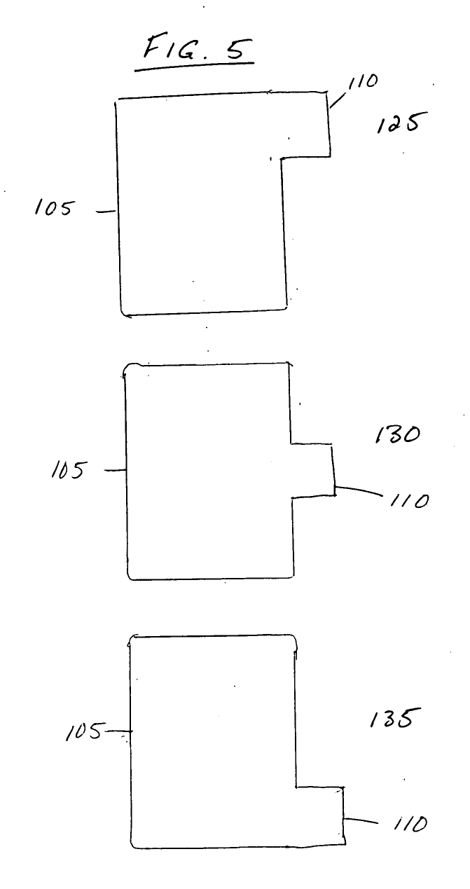

Referring to FIGS. 3 and 4, the label 100, 200 can be inserted into an organizer 300, 400. The organizer 300, 400 has square pockets 115 or rounded pockets 215 attached to an outer case 120, 220. Preferably, when the insertion card 105, 205, is inserted in the pockets, 115, 215, the identifier tab 110, 210, extends to a position between the edge of the pockets 115, 215 and the outer case 120, 220.

The insertion cards may also have other shapes that are configured to fit into a pocket of an organizer. The identifier tab may also have varying shapes, but, preferably, includes a writing surface to identify the contents of the pocket with a symbol, text, or other printed identification.

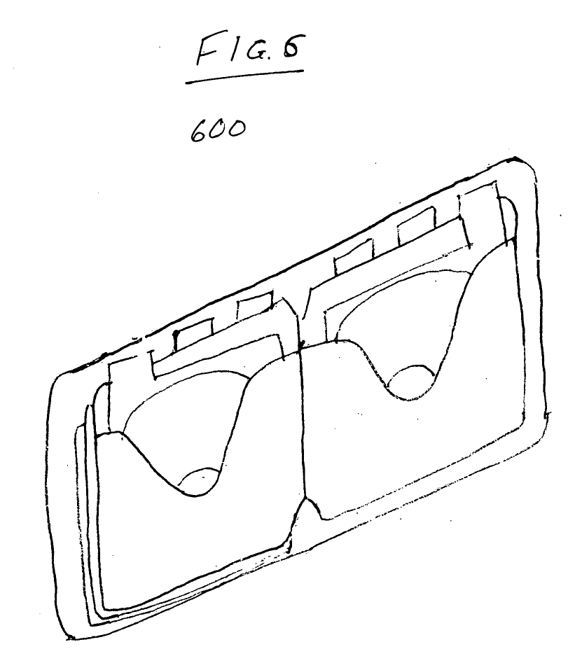

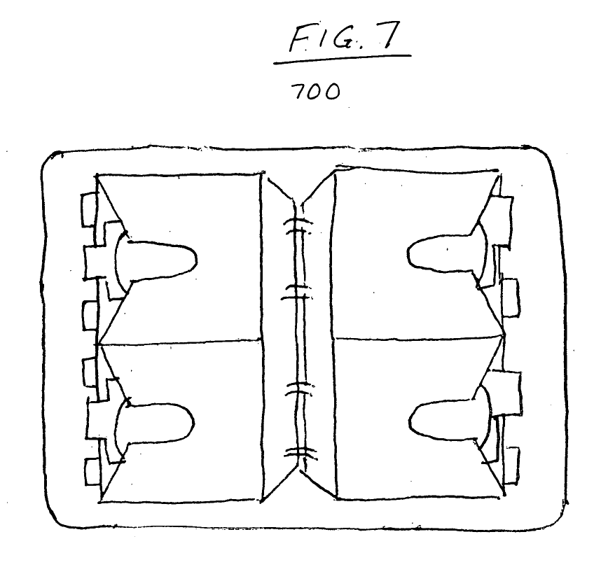

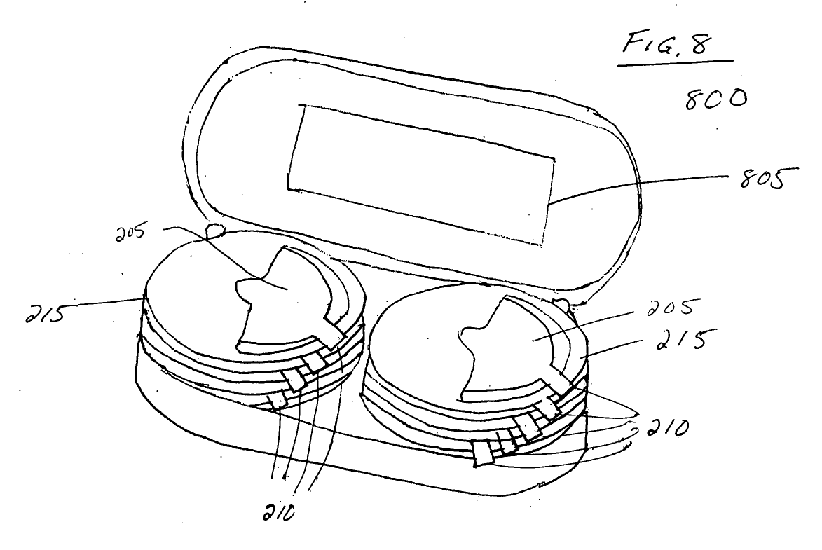

Referring to FIGS. 5-7, a series of labels 125, 130, 135 may be used to identify CDs in organizers 600, 700 with multiple pockets. In this implementation, each label 125, 130, 135 may have an identifier tab 110 extending from the insertion card 105 at different positions. For example, the first label 125 has an identifier tab 110 extending from an upper portion of the insertion card 105. The second label 130 has an identifier tab 110 extending from a mid-portion of the insertion card 105. The third label 135 has an identifier tab 110 extending from a lower portion of the insertion card 105. Thus, when the labels 125, 130, 135 are inserted into multiple pockets of the organizer, each identifier tab 110 is at least partly visible without obstruction from the other identifier tabs 110.

FIG. 8 shows an organizer 800 having multiple circular pockets. The insertion cards 205 are inserted in each pocket 215 in a rotational pattern relative to each other such that each identifier tab 210 is visible when the pockets 215 are stacked on top of each other.

The organizer 800 also may have a separate index 805 that identifies the contents of each pocket 215. The index 805 can be attached to the organizer 800 with an adhesive or may be inserted into a separate pocket on the inside of the front cover of the organizer. As shown, the index 805 is rectangular but also may be another shape suited to fit inside the front cover, the back cover, or an outside surface of the front or back cover. In another implementation, more than one index 805 is inserted between groups of pockets 215 of the organizer.

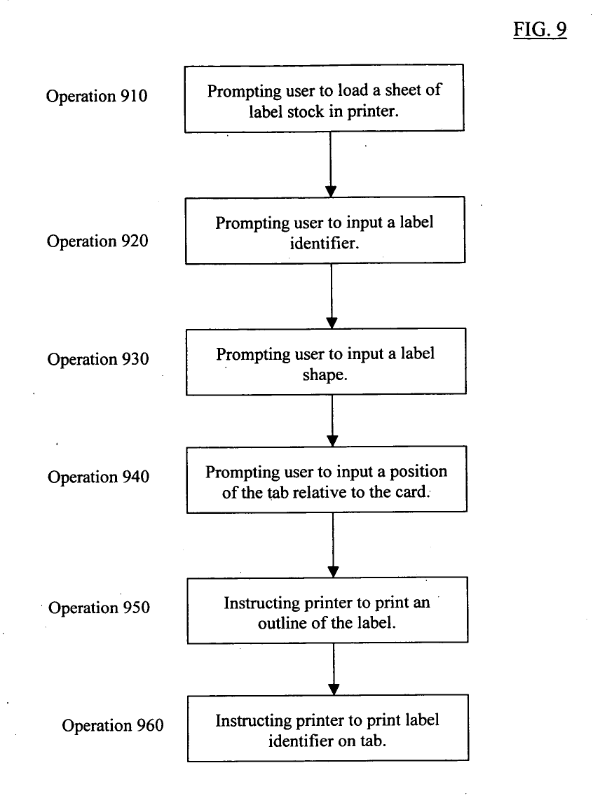

Referring to FIG. 9, a software program 900 can be utilized as a method to prepare CD organizer labels. In operation 910, the program 900 prompts the user to add a sheet of label stock to a printer. The user is then prompted to input a label identifier in operation 920. The label identifier may be text or a symbol and may correspond to the same information that is printed on an index in the front of the organizer.

The user is prompted to identify a shape of the insertion card portion of the label in operation 930. Typically, the insertion card may be square, rectangular, or circular. However, any shape may be used that allows the insertion card to be inserted into the pocket.

The user is prompted to input a position of the identifier tab relative to the insertion card in operation 940. The position of the identifier tab may be varied by the user depending on the number of pockets in the organizer. Then, an outline of the label is printed on the cardstock in operation 950 and the identifier is printed on the identifier tab in operation 960.

Since certain changes may be made in the above apparatus and program without departing from the scope of the invention herein involved, it is intended that all matter contained in the above description or shown in the accompanying drawing shall be interpreted in an illustrative and not in a limiting sense. For example, advantageous results still could be achieved if operations of the computer program were performed in a different order and/or if components in the disclosed systems were combined in a different manner and/or replaced or supplemented by other components. Accordingly, other implementations are within the scope of the following claims.

1. A label for a media disk storage device having more than one pocket moveably attached to a binder in a stacked arrangement, the label comprising:
an insertion card insertable within the pocket; and
an identifier tab extending from the insertion card to a position beyond an edge of the pocket when the insertion card is inserted in the pocket.

2. The label of claim 1, wherein the identifier tab comprises a printable surface.

3. The label of claim 1, wherein an identifier on the identifier tab comprises a symbol.

4. The label of claim 1, wherein the identifier tab comprises a semi-circular shape.

5. The label of claim 1, wherein the identifier tab comprises a rectangular shape.

6. The label of claim 1, wherein the insertion card comprises a rectangular shape.

7. The label of claim 1, wherein the insertion card comprises a circular shape.

8. The label of claim 1, wherein the insertion card comprises a square shape.

9. A media disk label. system for a media disk organizer having a first pocket, a second pocket, and a third pocket moveably attached to a binder in a stacked arrangement, the label system comprising:
a first label having a first insert portion and a first tab extending from a left side of the first insert portion to a position beyond an edge of the first pocket when the first insert portion is positioned in the first pocket;
a second label having a second insert portion and a second tab extending from a middle-portion of the second insert portion to a position beyond an edge of the second pocket when the second insert portion is positioned in the second pocket; and
a third label having a third insert portion and a third tab extending from a right side of the third insert portion to a position beyond an edge of the third pocket when the third insert portion is positioned in the third pocket.

10. The media disk label system of claim 9, further comprising:
an index referencing a location of media disks stored in the first pocket, the second pocket, and the third pocket, the index being attachable to the organizer.

11. The media disk label system of claim 9, further comprising:
a sheet having perforations configured to be separated into the first label, the second label, and the third label.

12. The media disk label system of claim 9, wherein the sheet comprises a printable surface.

13. A method of organizing media disks in a disk holder having more than one pocket moveably attached to a binder, the method comprising:
providing a label having an insert portion and an identifier tab extending from the insert portion, the identifier tab being visible from outside of the pocket when the insert portion is inserted in the pocket.

14. The method of claim 13, further comprising:
printing an identifier on the identifier tab; and
providing an index having the identifier identifying a media disk stored in the pocket.

15. The method of claim 13, further comprising:
inserting the insert portion of the label into each pocket of the disk holder.

16. The method of claim 13, further comprising:
providing a computer program operable to instruct a computer system having a printer to print an identifier on the label.

17. A computer program, stored on a computer readable medium, to prepare labels used in a media disk organizer having separate pockets, the computer program comprising instructions to:
cause a printer to print an outline of a label having an insert portion and an identifier tab extending from the insert portion.

18. The computer program of claim 17, further comprising instructions to:
cause a computer user interface to prompt a user for an identifier; and
cause the printer to print the identifier on a printable surface of the identifier tab.

19. The computer program of claim 17, further comprising instructions to:
cause the printer to print an index having the identifier.

20. The computer program of claim 17, further comprising instructions to:
cause a computer user interface to prompt a user to load a sheet of label stock in a printer, the label stock having perforations configured in the shape of the label.

21. The computer program of claim 17, further comprising instructions to:
assign an identifier to each label; and
cause the printer to print the identifier on each label and on an index.

22. The computer program of claim 17, further comprising instructions to:
cause a computer user interface to prompt the user to print the label.
